(19) United States
(12) Patent Application Publication
(10) Pub. No.: US 2020/0238615 A1
(43) Pub. Date: Jul. 30, 2020

(54) ADDITIVE MANUFACTURING DEVICE AND SYSTEM, MODULAR BUILD PLATFORM AND BUILD PLATFORM UNIT

(71) Applicant: AddiFab ApS, Jyllinge (DK)

(72) Inventors: Lasse Guldborg Staal, Jyllinge (DK); Jon Jessen, Veksø (DK); Peter Lund Sørensen, Vipperød (DK)

(21) Appl. No.: 15/760,732

(22) PCT Filed: Sep. 26, 2016
(86) PCT No.: PCT/EP2016/072825

§ 371 Date: Mar. 16, 2018

(30) Foreign Application Priority Data
Sep. 25, 2015 (DK) PA 2015 70610

(51) Int. Cl. B29C 64/245; B33Y 30/00

(52) U.S. Cl. CPC B29C 64/245; B33Y 30/00

(57) ABSTRACT

The present invention relates to an additive manufacturing device (100) for manufacturing a product (201), wherein the additive manufacturing device (100) comprises a build platform (200) comprising a build surface (260) configured to hold or support, during use, at least one product (201) being manufactured by an additive manufacturing process, wherein the build platform (200) is a modular building platform comprising at least one of a plurality of separable or separate modular build platform units (210), each comprising at least one build surface (260) configured to hold or support, during use, at least one product (201) being manufactured during the additive manufacturing process.

### FIELD OF THE INVENTION

The invention relates generally to an additive manufacturing device for manufacturing a product, wherein the additive manufacturing device comprises a build platform comprising a build surface configured to hold or support, during use, at least one product being manufactured during the additive manufacturing process, and a modular build platform unit for an additive manufacturing device.

### BACKGROUND

Additive manufacturing—also called 3D printing—has become an important product development tool. Rapid prototyping, iterative design and concept validation are three disciplines that are considerably facilitated by 3D printers. Several different 3D printing platforms are commercially available in the market today, and each of these platforms have important characteristics and advantages that a product developer may exploit to create design models, demonstrators, functional prototypes and small batches of components for product validation.

Many developments in relation to additive manufacturing aims at improving the capabilities towards mass manufacturing of products with more consistent quality between manufactured products, lower manufacturing costs pr. manufactured product, etc.

One trend aiming at bringing the manufacturing costs down pr. manufactured product involves increasing the physical dimensions of the build platform further and further and manufacturing larger and larger batches of a single product. However, for certain additive manufacturing devices, this increases the size and costs of the manufacturing equipment. Additionally, creating large batches of a given product presents challenges in connection with consistency among the products. Time per batch increases due to the need to move energy- and/or light-sources and optics over a larger area, and costs tied to work-in-progress and scrapped components increase with the number of components produced in a single batch. Finally, preparing larger and larger batches of components increases the necessary volume and surface area of curable liquid or other material needed and thereby the size of container(s) or vat(s) containing or supplying the liquid or material during manufacture. Such liquids or materials are generally costly, and increasing the size of container(s) or vat(s) presents drawbacks e.g. in connection with contamination as the whole or large parts of the liquid or material may need to be replaced in case of a contamination.

German utility model DE 299 07 262 U1 discloses a device for manufacturing three dimensional objects where the device comprises a base plate having on top a releasable mounting plate for supporting a number of build platforms. The build platforms are secured to the mounting plate using a number of clamping elements spaced between the build platforms, each clamping element having a T-shaped cross-section engaging lengthwise grooves in the respective build platforms. The clamping elements are secured to the mounting plate using screws or similar threaded mechanical securing elements. The use of screws or similar threaded mechanical securing elements hinders efficient handling and in particular hinders automatic or semi-automatic handling as screws and clamping elements will have to be manipulated to ensure proper positioning and alignment. In addition, screws, clamps, guide-pins and their respective interfaces to the build platforms are subject to wear and tear and will degrade over time, which may impact on the precision of positioning of the build planes.

Additionally, the build platforms cannot be placed immediately next to each other, i.e. with no or little space between them, as there needs to be space for the screws and clamping elements, as well as the tools needed for their removal, in between the build platforms. This reduces the overall usable area for manufacturing products as a gap is present between the individual build platforms to allow room for the clamping elements. A reduced overall usable area for manufacturing of objects may have a significant impact in relation to yield, especially for mass manufacturing as opposed to prototyping, etc.

Additionally, the gap between the build platforms may effectively hinder manufacturing an object across several build platforms.

Additionally, the manufacturing device according to DE 299 07 262 U1 is not well suited for top projection additive manufacturing methods as such methods would entail that the clamping elements and securing elements are fully immersed into a radiation-curable liquid. Over time, such radiation-curable liquid may accumulate and cure in holes and threads, thus hindering the proper function of the screws and clamping elements.

### SUMMARY

It is an object to alleviate at least one or more of the above mentioned drawbacks at least to an extent.

The invention is defined in claim 1.

Accordingly, in one aspect of the present invention is provided an additive manufacturing device for manufacturing a product, wherein the additive manufacturing device comprises a build platform comprising a build surface configured to hold or support, during use, at least one product being manufactured by an additive manufacturing process, wherein the build platform is a modular building platform comprising at least one (e.g. one or two or more than two) of a plurality of separable or separate modular build platform units, each separable or separate modular build platform unit comprising at least one build surface configured to hold or support, during use, at least one product being manufactured during the additive manufacturing process.

In this way, an additive manufacturing device is enabled where a build platform may be composed or configured according to a given use, preference, or need; e.g. depending on whether one large product is to be manufactured, or whether several small products are to be manufactured, or whether a mix of sizes are to be produced, etc.

This enables lower manufacturing costs and greater flexibility—both for manufacturing a variety of individual products and for manufacturing e.g. assembly kits, kits of parts, or the like. In cases of an assembly kit, kit of parts, or the like, each component may even be handled or processed individually (e.g. individual coating, mechanical post-processing like milling, gluing, sintering, etc.) after which the full assembly kit, kit of parts, or the like in the end may be assembled, packaged, shipped, and delivered, e.g. automatically.

It should be noted, that the term “the build platform is a modular building platform comprising at least one of a plurality of separable or separate modular build platform units” means that more than one of separable or separate modular build platform units are present or available but that the build platform may, in some uses or situations, comprise only a single separable or separate modular build platform unit according to the present invention although much more often the build platform will comprise a plurality of separable or separate modular build platform units. The modularity and the ensuing possible adaptations and customisations provide several advantages.

In some embodiments, the build platform comprises at least two of the separable or separate modular build platform units.

In this context, the at least one of a plurality of separable or separate modular build platform units together will form the (overall) build platform.

In some embodiments, the plurality of separable or separate modular build platform units is adapted to form the build platform as a single coherent build platform.

In some embodiments, the modular building platform comprises at least two, at least four, at least 6, at least 8, at least 12, at least 18, or at least 24 separable or separate modular build platform units. The number of separable or separate modular build platform units may also be an uneven number.

The additive manufacturing device may also comprise at least one carrier platform, each carrier platform being adapted to connect releasably to or attach releasably with, during use, at least one, often a plurality, of the separable or separate modular build platform units.

In this way, one carrier platform comprising a plurality of separable or separate modular build platform units enables more efficient handling since handling one carrier platform enables handling several separable or separate modular build platform units. In addition, automated or semi-automated handling is facilitated by handling the carrier platform.

When handling the separable or separate modular build platform units they (or some of them) may be handled together (aggregated handling) and/or they may be split up and handled separately. Splitting up may e.g. be useful for when an additively manufactured product needs to be accessed from a side (by (post)processing equipment) and an adjacent other additively manufactured product would otherwise block access. Splitting up may e.g. also be useful when a series of additively manufactured products are to be fitted together or assembled, but where at least some require different (post)processing. Splitting up is also advantageous for one or more additively manufactured products that are—or comprise—single-use moulds and in particular when filling of the mould(s) and/or coating needs to done in a plane that is not parallel to the building platform's sides, i.e. more or less freely in 3D.

In some embodiments, at least one or some of the separable or separate modular build platform units each comprises one or more first securing elements. In some further embodiments, at least one or some of the carrier platforms each comprises one or more second securing elements, wherein the first securing elements and the second securing elements are adapted to releasably secure, during use, one or more, e.g. one or two or more, given modular build platform units to a given carrier platform.

In some embodiments, the one or more modular build platform units, each comprising one or more first securing elements, is or are adapted to be releasably secured to a respective carrier platform along
a general direction being substantially perpendicular to a build surface of the respective build platform comprising the one or more modular build platform units, and/or
a general direction being substantially perpendicular to a side of the carrier platform to which the one or more modular build platform units is to be releasably secured.

The two mentioned general directions may be the same or be parallel as the build surface may generally be parallel to a side of the carrier platform to which the one or more modular build platform units are to be releasably secured.

In this way, the build surface area available for receiving one or more products being manufactured is maximised as much as possible and ‘dead’—or unusable—space is minimized.

In some embodiments, the one or more first securing elements for a separable or separate modular build platform unit is located on a side that is opposite a side with the build surface of the separable or separate modular build platform unit.

In some embodiments, the one or more first securing elements of a separable or separate modular build platform unit is or are protruding from the separable or separate modular build platform unit. This further simplifies handling, in particular automatic or semi-automatic handling.

In some embodiments, each respective separable or separate modular build platform unit comprises (precisely) one first securing element that is located centrally on a side of the respective separable or separate modular build platform unit. In some further embodiments, it is not all separable or separate modular build platform units that comprise a first securing element. The first securing element may e.g. be located on a side of a respective separable or separate modular build platform unit that is opposite the build surface side of the respective separable or separate modular build platform unit.

In some embodiments, the one or more second securing elements comprises one or more standardised industrial chucks and the one or more first securing elements are adapted to be secured, during use, by a standardised industrial chuck. In some further embodiments, the first securing elements are each an Erowa spigot or similar, mating (in addition to other tools or equipment) with a second securing element in the form of a standardised industrial chuck, like an Erowa chuck. Alternatively, other releasable securing elements may be used e.g. like bayonet clamps, magnets, vacuum, etc.

In some embodiments, the build platform comprises at least two of the plurality of separable or separate modular build platform units and wherein at least one of the at least two separable or separate modular build platform units is located adjacent or next to at least one other separable or separate modular build platform unit of the at least two separable or separate modular build platform units, e.g. when located on a carrier platform or for embodiments without a carrier platform then just in general.

In some embodiments, the build platform comprises at least two of the plurality of separable or separate modular build platform units and wherein at least one of the at least two separable or separate modular build platform units is located directly adjacent to at least one other separable or separate modular build platform unit of the at least two separable or separate modular build platform units, e.g. when located on a carrier platform or, for embodiments without a carrier platform, then just in general.

In this context “adjacent” is to include adjacent including a relatively small gap, e.g. such as preferably less than 10 mm, more preferably less than 5 mm, or even more preferably less than 1 mm but more than 0.5 mm and “directly adjacent” is to mean that the separable or separate modular build platform units are next to each other, e.g. with a small air gap less than 0.5 mm and e.g. with a small air gap in the range of about zero to about micrometres.

In some embodiments, each of the plurality of separable or separate modular build platform units is adjacent or directly adjacent to at least one other separable or separate modular build platform unit, e.g. when located on a carrier platform or for embodiments without a carrier platform then just in general.

In some embodiments, the one or more first securing elements is further adapted to enable, during use, a given modular build platform unit to be handled by, or secured to, at least one handling and/or processing equipment.

In some embodiments, the carrier platform comprises one or more handling or securing elements enabling the given carrier platform to be handled by or secured to at least one handling and/or processing equipment.

In some embodiments, one or more of the at least one carrier platform, each comprises a lock-and-release system adapted to lock or unlock one or more second securing elements of a given carrier platform, preferably on an individual basis (i.e. respective lock/release is enabled separately for the individual modular platform unit), in dependence on a received control signal. A control circuit, e.g. an electrical circuit, a pneumatic circuit, a hydraulic system, a lever system, etc., may e.g. supply the control signal. In the case of a pneumatic circuit/control signal it may be beneficial if its open state governs release. In the case of a hydraulic system/control signal it may be beneficial if its closed state governs release.

In this way, simple lock and release control, as well as automated mounting and removal of the one or more modular build platform units, may be enabled.

In some embodiments, one or more of the at least one carrier platform, each comprises a lock-and-release system adapted to lock or unlock one or more second securing elements of a given carrier platform along
a general direction being substantially perpendicular to a build surface of the respective build platform comprising the one or more modular build platform units, and/or
a general direction being substantially perpendicular to a side of the carrier platform to which the one or more modular build platform units is to be releasably secured.

Again the two mentioned general directions may be the same or be parallel.

Locking and unlocking in either of these two perpendicular directions is different e.g. from being locked, requiring movement or operation of at least one mechanical element, from any side of the build platform, e.g. as in DE 299 07 262 U1. Avoiding this, simplifies handling, in particular automatic or semi-automatic handling.

In some embodiments, at least some, preferably all, of the separable or separate modular build platform units, each comprises a unique identifier uniquely identifying the given modular build platform unit.

In some embodiments, the unique identifier is selected from the group of: a radio frequency identification (RFID) tag or similar, a fiducial e.g. to be used in a vision or an imaging system, a barcode, a dot matrix code, laser engraving(s), colour coding(s) or marking(s).

In some embodiments, one or more of the modular build platform units (so not necessarily all of them), each comprises an interface element that may be removable and is located on—and may be firmly and/or releasably attached to—a top surface of the given modular build platform unit wherein the build surface configured to hold or support, during use, at least one product being manufactured then is the removable interface element rather than the surface of the given modular build platform unit. The top, in this respect, is the surface facing (and holding or supporting) a product manufactured or being manufactured on the modular build platform, i.e. the build surface. For embodiments where the interface element is removable, attachment features may for instance comprise click fits, magnets, vacuum suction, grooves, rails, or similar.

In a particular set of embodiments, the interface element may be made of metal, plastic, glass or another material, and may comprise an absorbing or/and flexible material that co-acts with a radiation-curable liquid to bond uncured radiation-curable liquid either via absorbing or securing the uncured radiation-curable liquid via hardening the liquid to a solid. This may be used to remove or empty the vat partly or completely from the liquid, and/or trap unwanted particles, debris, or broken components from failed builds. The absorbing or/and flexible material may have a surface parallel to the build surface, or may have a surface that is angled/oblique, which facilitates removal.

Exemplary absorbing materials may for instance be woven fabrics, meshes, grids, scaffolds, porous coatings, fibrous materials, sponges or spongy materials, and other non-repellent materials.

In some embodiments, the build surface of the build platform and/or the build surface of the modular build platform units comprises an absorbing material.

In some embodiments, the build surface of the build platform and/or the build surface of the modular build platform units comprises a removable or non-removable interface element.

In some embodiments, a plurality of separable or separate modular build platform units of a build platform is separated into a first and at least a second group wherein the first group is transferred to a first post-processing device for processing and the second group is transferred to a second post-processing device for other or different processing.

Exemplary (post)processing and/or uses may include 2D or 3D pick and place (insertion of elements, components, or parts), cnc or other milling/lathing, filling (in case of moulds, casts or other hollow structures), laser coding, engraving, tampon printing, PCB circuit sintering, part insertion, multi-material building, gluing, assembly, packaging, sterilisation, tampon printing, 3D coating and/or painting of one or more additively manufactured products, etc.

An additively manufactured product may e.g. be used as a tool for a given function (e.g. including the build platform) where the tool/product may be discarded after use while the build platform is re-used.

In some embodiments, two or more additively manufactured products are manufactured on respective different separable or separate modular build platform units manufactured on the same building platform where the two or more products are injection moulding parts for injection moulding that fit and can be used together for moulding. In such embodiments, the two or more injection moulding parts may be used subsequently in an injection moulding device wherein they are mounted in the injection moulding device together. For some applications, the modular build platform units are mounted in the injection moulding device while still being placed on the respective modular build platform unit whereby they constitute a respective moulding part that may be brought together to form a mould. For some of these applications, the lock-and-release system that is used to provide releasable securing of the build platform to the additive manufacturing device and/or the carrier platform is also used to releasably secure the modular build platform units with the two injection moulding parts in the injection moulding device in a way that allows the two or more injection moulding parts to be joined to form an injection moulding cavity as part of the normal operation of the injection moulding machine. In some embodiments, the modular build platform units with the injection moulding parts and/or the lock-and-release system are adapted to directly accommodate the injection moulding, e.g. by having one or more suitable channels, inlets, etc. allowing a required flow of material, such as thermoplastic material, to be used for the actual injection moulding. Thus, automated loading and release of the injection moulding parts is supported and it is e.g. not required to release the additively manufactured injection moulding parts (or other types of moulds) from the respective build platform/modular build platform unit.

In some embodiments, the build platform, and thereby the least one of a plurality of separable or separate modular build platform units, is for one-time use only.

In some embodiments, the build platform and/or the modular build platform units comprises one or more cleaning or flushing channels ending in one or more cavities and/or openings, wherein the cleaning or flushing channels are adapted to receive, during use, one or more cleaning agents and/or pressurised air thereby cleaning the at least one product being held or supported by the build platform, vat or container comprising a liquid used for the manufacturing of the product(s), and/or the modular build platform units.

In some embodiments, the build platform and/or the modular build platform units comprises one or more channels ending in one or more cavities and/or openings, wherein the channels are adapted to receive, during use, one or more fluid heating or cooling agents (i.e. liquid or gaseous (e.g. carbon dioxide, air, nitrogen gas, etc.) heating or cooling agents) thereby heating or cooling, respectively, one or more additively manufactured products or products being additively manufactured (e.g. an injection moulding part) being supported by the build platform and/or the modular build platform units. These channels may be overlapping, be coinciding, or be different than the cleaning or flushing channels.

In some embodiments, the build platform and/or the modular build platform units comprises one or more channels or inlets configured to receive a thermoplastic material adapted to be injected by an injection moulding device as part of an injection moulding process. In some further embodiments, a lock-and-release system as disclosed herein comprises one or more channels or inlets configured to also receive the thermoplastic material.

According to another aspect is provided a modular build platform unit for an additive manufacturing device, the modular build platform unit comprising at least one build surface configured to hold or support, during use, at least one product being manufactured by an additive manufacturing process carried out by the additive manufacturing device, wherein the modular build platform unit is adapted to form, during use, a single unitary build platform when joined or used together with at least one other modular build platform unit.

According yet to another aspect is provided a modular build platform for an additive manufacturing device comprising at least one build surface configured to hold or support, during use, at least one product being manufactured by an additive manufacturing process, wherein the build platform comprises at least one of a plurality of separable or separate modular build platform units, each separable or separate modular build platform unit comprising at least one build surface configured to hold or support, during use, at least one product being manufactured during the additive manufacturing process.

In some embodiments, a modular build platform/the build platform and/or one or more modular build platform units is or are for one-time use only.

According to another aspect is provided an additive manufacturing device system comprising at least one additive manufacturing device according to any one of claims 1-28.

According to another aspect is provided a build platform comprising one or more cleaning or flushing channels ending in one or more cavities and/or openings, wherein the cleaning or flushing channels are adapted to receive, during use, one or more cleaning agents and/or pressurised air thereby cleaning the at least one product. Alternatively or complementarily, heating or cooling fluids may be circulated through these channels (or other or additional channels) and/or the manufactured parts, e.g. before and/or during an injection moulding process, to ensure an appropriate temperature of operation.

Provision of such channels enables release, and/or build up, of vacuum, over-pressure, or under-pressure created in cavities of additively manufactured products during manufacture e.g. by a pump or similar capable of releasing pressurised air or similar and/or suction, addition of resin, curable liquid, filling material or the like to a build vat and/or the inner part of an additively manufactured product during manufacture;

It should be noted, that the aspect of one or more cleaning or flushing channel in principle is independent of whether the build platform comprises build platform units or not (although they also work particular well with these).

Alternatively or complementarily, one or more channels may be configured to serve as injection moulding inlets, and to receive thermoplastic material that is injected by an injection moulding device as a part of an injection moulding process. A particular advantage of such a configuration is that it considerably reduces the stress that is experienced by the additively manufactured part or parts during injection of the injection moulding material.

### Definitions

All headings and sub-headings are used herein for convenience only and should not be constructed as limiting the invention in any way.

The use of any and all examples, or exemplary language provided herein, is intended merely to better illuminate the invention and does not pose a limitation on the scope of the invention unless otherwise claimed. No language in the specification should be construed as indicating any non-claimed element as essential to the practice of the invention.

This invention includes all modifications and equivalents of the subject matter recited in the claims appended hereto as permitted by applicable law.

### BRIEF DESCRIPTION OF THE DRAWINGS

FIG. 1 schematically illustrates a perspective view of a carrier platform supporting a build platform according to one aspect of the present invention;

FIG. 2 schematically illustrates a perspective view of the build platform and the carrier platform of FIG. 1 where the build platform is shown as being separated from the carrier platform;

FIG. 3 schematically illustrates a perspective of the carrier platform of FIG. 1 supporting a single modular build platform unit as also shown in FIG. 1;

FIG. 4 schematically illustrates a perspective view of the carrier platform and the modular build platform unit of FIG. 3 where the modular build platform unit is shown as being separated from the carrier platform;

FIG. 5 schematically illustrates a perspective view of the carrier platform and the modular build platform unit of FIG. 3 shown from another view;

FIG. 6 schematically illustrates a side view of a carrier platform supporting a build platform with a control circuit indicated;

FIG. 7 schematically illustrates one embodiment of an additive manufacturing device that the various embodiments of a carrier platform and of a build platform as shown in FIGS. 1-6 and 10 may be used in connection with;

FIG. 8 schematically illustrates another embodiment of an additive manufacturing device that the various embodiments of a carrier platform and of a build platform as shown in FIGS. 1-6 and 10 may be used in connection with;

FIG. 9 schematically illustrates an additive manufacturing system that may employ the various embodiments of one or more carrier platforms and of one or more build platforms e.g. as shown in FIGS. 1-6 and 10; and

FIG. 10 schematically illustrates a further aspect where a build platform comprises one or more cleaning or flushing channels or the like.

### DETAILED DESCRIPTION

Various aspects and embodiments of an additive manufacturing device and system, and modular build platform and build platform unit for the same as disclosed herein will now be described with reference to the figures.

When/if relative expressions such as “upper” and “lower”, “right” and “left”, “horizontal” and “vertical”, “clockwise” and “counter clockwise”, “top” and “bottom” or similar are used in the following terms, these refer to the appended figures and not necessarily to an actual situation of use. The shown figures are schematic representations for which reason the configuration of the different structures as well as their relative dimensions are intended to serve illustrative purposes.

Some of the different components are only disclosed in relation to a single embodiment of the invention, but is meant to be included in the other embodiments without further explanation.

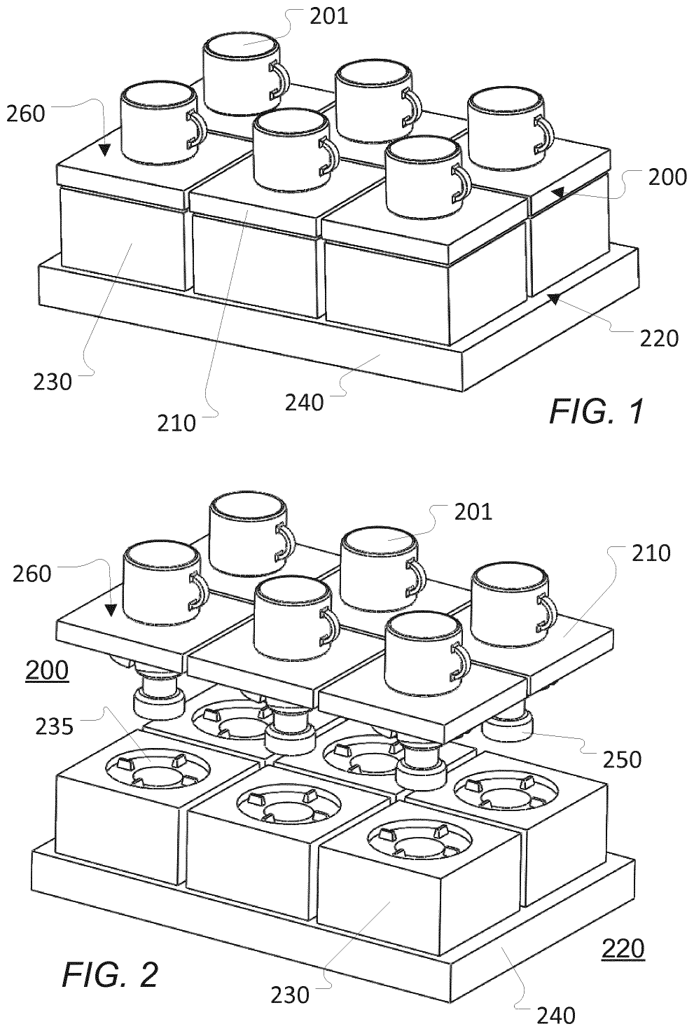

FIG. 1 schematically illustrates a perspective view of a carrier platform supporting a build platform according to one aspect of the present invention.

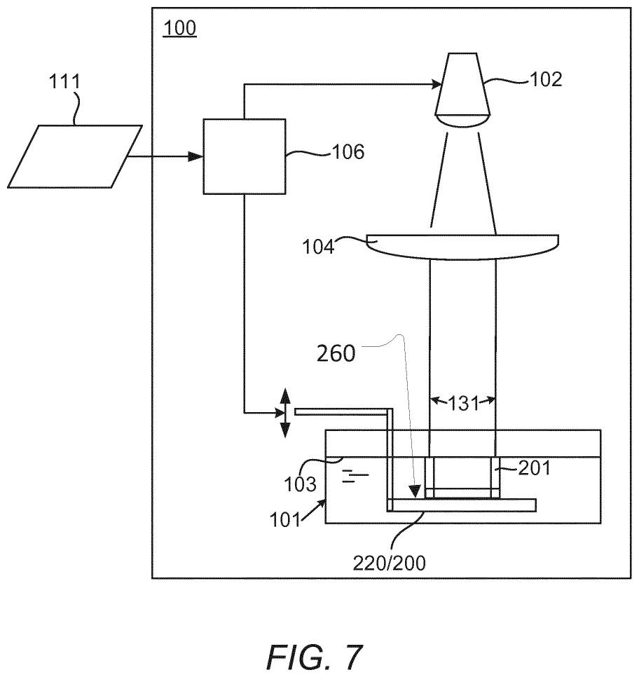

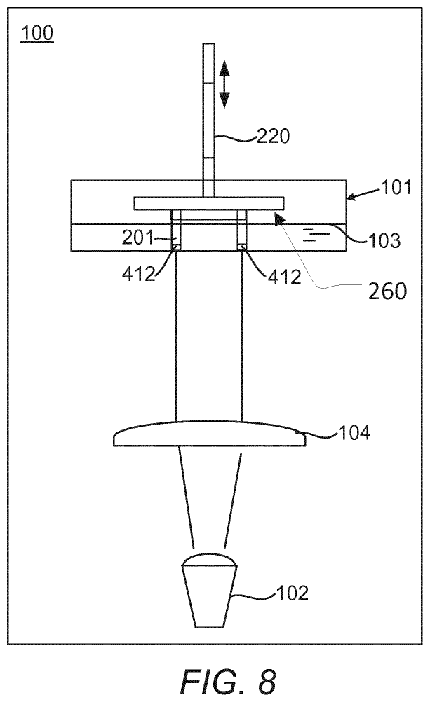

Shown is a carrier platform 220 supporting a build platform 200 that may form part of an additive manufacturing device (see e.g. 100 in FIGS. 7, 8, and 9) or may be used in connection with such a device as will be explained in the following. The additive manufacturing device may e.g. be a top-projection based 3D printer system (see e.g. 100 in FIG. 7), a bottom-projection based 3D printer system (see e.g. 100 in FIG. 8), another 3D printing system, a laser sintering system, a protrusion system, an extrusion-based 3D printer system, a 3D bio-printing or bio-plotting system, a fused deposition modelling (FDM) system, a material jetting system, a 2 photon printing system, a 3D lamination printer, an aerosol 3d printing system, a heat sintering system, a sugar crystal fusion 3dprinter, or any other suitable additive manufacturing system.

The build platform 200 comprises a build surface 260 configured to hold or support, during use, at least one product 201 being manufactured by an additive manufacturing process. For additive manufacturing processes, the product(s) 201 may e.g. be manufactured using one or several energy- and/or light-sources. Shown in FIG. 1, purely as an example, are six produced objects 201.

According to an aspect of the present invention, the build platform 200 is a modular building platform comprising at least one of a plurality of separable or separate modular build platform units 210 where each modular build platform unit 210 comprises a build surface 260 configured to hold or support, during use, at least one product 201 being manufactured during the additive manufacturing process.

It should be noted, that the build platform units 210 may be connected (and then being separable), i.e. a build platform unit 210 is connected (and separable) to at least one other build platform unit 210, or may be fully separate (e.g. as shown most clearly in FIG. 6). Even if fully separate they will still together constitute the (overall) build platform 200.

Even though the products 201 are shown in the figure as being the same (which may be the case) it is to be understood that the build platform 200 may support different types of products, i.e. different products may be manufactured at the same time, also of different sizes. It is also to be understood that a given modular build platform unit 210 may hold or support one or more products 201 that in case of more than two may be corresponding or different products. As shown, purely as an example, each modular platform unit 210 holds or supports one product 201.

It is also to be understood that the different modular build platform units 210 do not need to be of equal size. A build platform 200 may e.g. be formed—depending of a particular use—by a number of modular build platform units 210 of equal or different sizes. In the case of different sizes, production of products of different sizes and/or shapes is readily enabled in a cost effective way since only a single manufacturing step may be needed to produce the products of different sizes and/or shapes.

For modular build platforms units 210 of different sizes, one size may e.g. be a base size (e.g. represented by 1×1) while other sizes may be multiples in either or both directions (e.g. represented by 2×1, 2×2, 2×3, 3×3, etc.). The other sizes may in some embodiments be formed by securing base size modular build platform units together.

A given area of the build surface 260, i.e. the surface area of a given modular build platform unit 210, may e.g. range from about 1×1 cm to about 40×40 cm—or even larger—depending on the particular use.

In some certain embodiments, a manufactured product may e.g. span several modular build platform units 210.

In the shown and corresponding embodiments, the carrier platform 220 is adapted to releasably connect with or releasably attach to, during use, at least one or some of the plurality of separable or separate modular build platform units 210.

In some embodiments, at least one or some of the separable or separate modular build platform units 210 comprises one or more first securing elements (not shown; see e.g. 250 in FIGS. 2-5) and the carrier platform 220 comprises one or more second securing elements 230, wherein the first securing elements and the second securing elements 230 are adapted to releasably secure, during use, a given modular build platform unit 210 to a given carrier platform 220, e.g. as will be explained further in connection with FIG. 2.

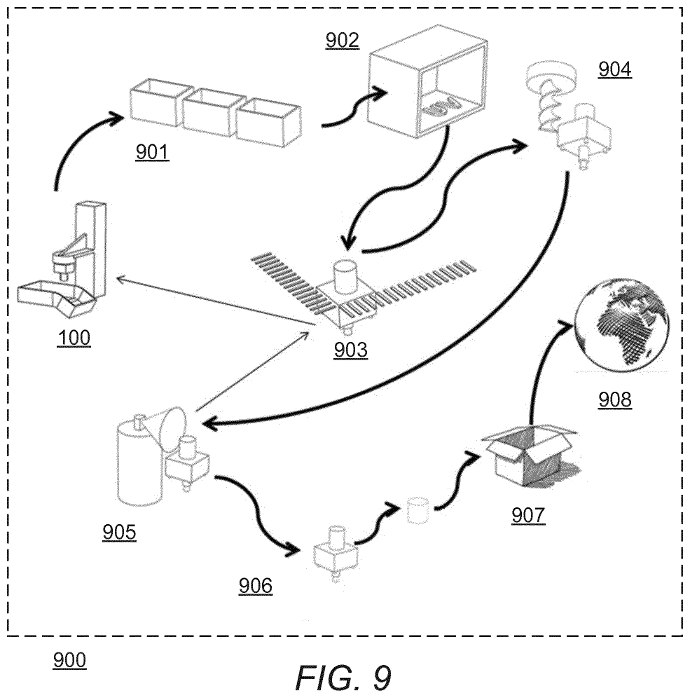

In some embodiments, the one or more first securing elements is/are further adapted to enable, during use, a given modular build platform unit 210 to be handled by or secured—e.g. automatically and either individually or collectively—to at least one handling and/or processing equipment (see e.g. FIG. 9). Alternatively, the handling elements may be different than the first securing elements.

In the shown and corresponding embodiments, the carrier platform 220 furthermore comprises a platform element 240 or other to support the one or more second securing elements 230.

The handling (e.g. mounting or release of the modular build platform units 210 in or from a carrier platform 220) may e.g. be done manually or e.g. automatically, e.g. using a robotic arm or gripping unit or other suitable transport mechanisms.

In the shown configuration, the carrier platform 220 comprises, purely as an example, six second securing elements 230, each second securing element 230 being for securing one single modular build platform unit 210.

In this way, an additive manufacturing device is enabled where a build platform 200 may be composed or configured according to a given use, preference, or need; e.g. depending on whether one large product is to be manufactured, or whether several small products are to be manufacture, or whether a mix of sizes are to be produced, etc. This enables lower manufacturing costs, greater flexibility, and/or to possibility of manufacturing an assembly kit, kit of parts, or the like.

In cases of an assembly kit, kit of parts, or the like, each component may even be handled or processed individually (e.g. individual coating, mechanical post-processing like milling, gluing, sintering, etc.) after which the full assembly kit, kit of parts, or the like in the end may be assembled, packaged, shipped, and delivered, e.g. automatically by a system such as the one shown in FIG. 9 or similar.

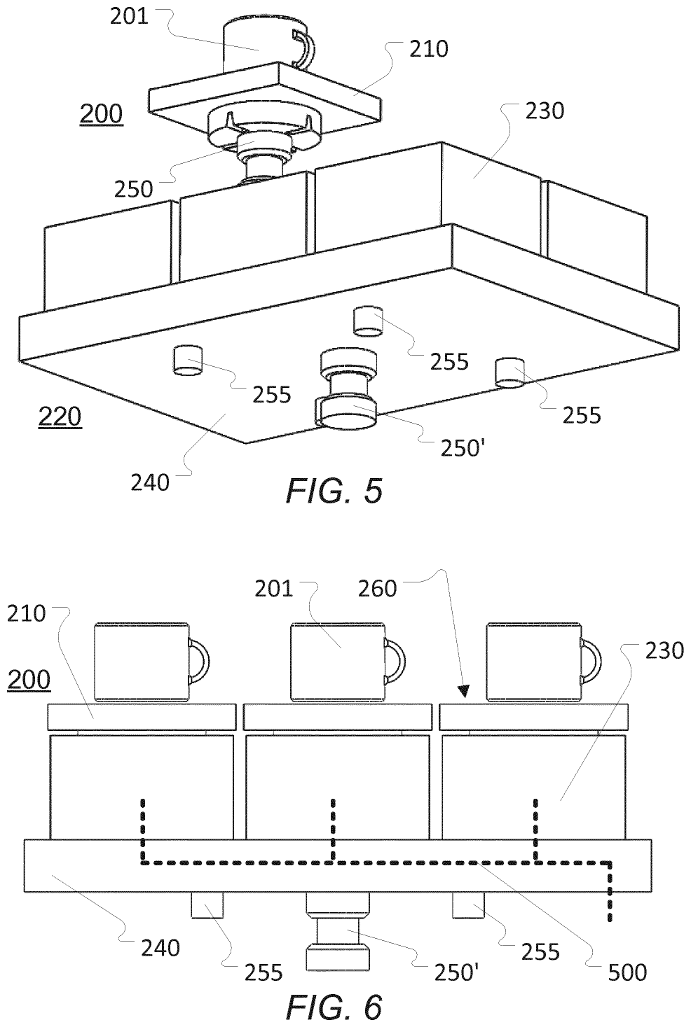

In some embodiments, the carrier platform 220 may e.g. also comprise securing elements (not shown; see e.g. 250′ in FIG. 5) enabling the given carrier platform 220 to be handled by or secured to at least one handling and/or processing equipment (see e.g. FIG. 9).

In some embodiments, one or more—preferably all—the separable or separate modular build platform units 210 comprises a unique identifier uniquely identifying the given modular build platform unit 210 (and thereby the product manufactured specifically on a particular modular build platform unit). This enables precise information and/or control of what product 201 is manufactured precisely at which modular build platform unit 210 and may also be used later in an overall—e.g. fully or partly automated—manufacturing and/or processing process (see e.g. FIG. 9), e.g. to determine where a given modular build platform unit 210 and its one or more products 201 is in the overall manufacturing and/or processing process and e.g. where it is to be moved to next.

As an example, in a situation where a build platform 200 comprising a number of modular build platform units 210 contains at least at some point different products 201, some of the products may e.g. be moved to a cleaning unit while other of the products may be moved to a post processing equipment, e.g. like milling, gluing, sintering, etc. equipment. This also enables optimisation of the overall manufacturing process in various ways.

In some embodiments, the unique identifier is a radio frequency identification (RFID) tag or similar. In some embodiments, the unique identifier is a fiducial e.g. to be used in a vision or an imaging system, etc. In other embodiments, the unique identifier may e.g. be selected from the group of barcodes, dot matrix codes, laser engravings, colour codings or markings, or any other suitable unique identifier.

In some embodiments, one or more parts of the build platform 200 (and thereby one or more of the modular build platform units 210, i.e. not necessarily all of them) comprise one or more interface elements that may be removable. These interface elements may be relatively thin elements e.g. sheets, plates, or other objects (equally referred to simply as interface elements throughout the specification and accompanying claims) located on top of the build platform 200/the (applicable) modular build platform unit(s) 210 where the product(s) is/are to be held or supported during manufacture, i.e. the interface element effectively becomes at least a part of the build surface 260 of the build platform 200/the (applicable) modular build platform unit(s).

In certain embodiments, each (relevant) modular build platform unit comprises one releasable interface element, etc.—although it may differ according to use.

The one or more interface elements, etc. may e.g. be made primarily of metal, glass, or plastic and may comprise an absorbing material. Exemplary absorbing materials may for instance be woven fabrics, meshes, grids, scaffolds, porous coatings, fibrous materials, sponges or spongy material, and other non-repellent materials.

It should be noted, that the build platform 200 and/or the modular build platform units 210 (or at least their respective build surfaces 260) may comprise an absorbing material—regardless of whether one or more interface elements are used and/or the material of the interface elements.

The interface elements, etc.—if used—may advantageously comprise the unique identifier mentioned above e.g. in addition to a corresponding unique identifier located on the modular build platform units 210 or alternatively instead of the one(s) located on the modular build platform units 210.

After manufacture, the one or more interface elements, etc. may e.g. then simply be removed or released from the build platform 200/the (applicable) modular build platform units 210 with the product(s) still attached and then post-processed, etc. and ultimately shipped—still with the product(s) attached—to an end user or client e.g. by a system such as the one shown in FIG. 9 or similar.

Accordingly, the build surface 260 of the build platform and/or the build surface 260 of the modular build platform units may e.g. comprise an absorbing material.

Accordingly, the build surface 260 of the build platform and/or the build surface 260 of the modular build platform units may e.g. comprise a removable or non-removable interface element.

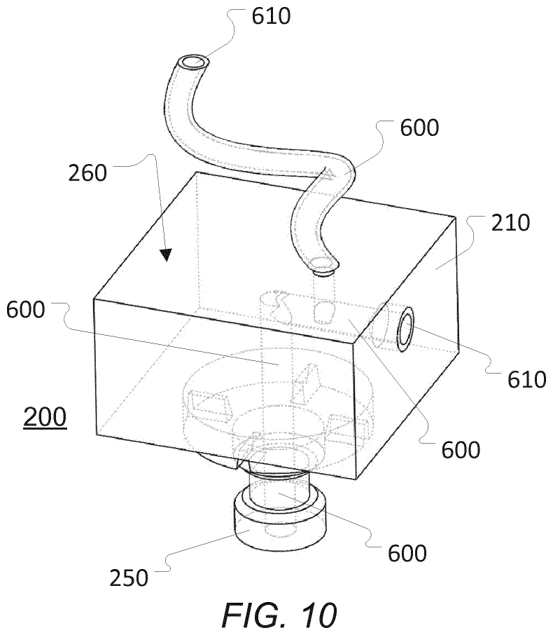

In some embodiments, the build platform 200 and/or the modular build platform units 210 comprises one or more cleaning or flushing channels ending in one or more cavities and/or openings (see e.g. 600 and 610 in FIG. 10), wherein the cleaning or flushing channels are adapted to receive, during use, one or more cleaning agents and/or pressurised air thereby cleaning the at least one product 201 and/or vat or container comprising a liquid used for the manufacturing of the product(s) 201.

The shown and corresponding embodiments of a build platform 200 and a carrier platform 220 are suitable for use in both top and bottom projection based additive manufacturing devices. In top projection, the carrier platform and the build platform(s) are simply lowered into the curable liquid between each exposure while in bottom projection, the carrier platform and the build platform(s) is lifted away from the curable liquid between each exposure.

In some embodiments, the build platform 200 (and thereby the modular build platform units 210 and e.g. the removable interface elements if present) is for one-time use only. In those instances, the build platform and/or removable interface elements may consist of bio-degradable material. Alternatively in other embodiments, the build platform 200/platform units 210 are for repeated use. When used for one-time use, the relevant part of the build platform/the relevant modular build platform units/the removable interface elements—including manufactured product(s)—may be shipped to another party (e.g. a party having ordered manufacture of the product(s)). This enables use of the received build platform/platform units e.g. for a post manufacturing process that the party themselves carry out.

FIG. 2 schematically illustrates a perspective view of the build platform and the carrier platform of FIG. 1 where the build platform is shown as being separated from the carrier platform.

In this figure, the build platform 200 is shown as being separated from the carrier platform 220 of FIG. 1 revealing further details.

As can be seen, each of the separable or separate modular build platform units 210 comprises one or more (here as an example only one) first securing element 250 and the carrier platform 220 comprises one or more (here as an example six) second securing elements 230. The first securing elements 250 and the second securing elements 230 are adapted to releasably secure, during use, a given modular build platform unit 210 to the carrier platform 220. In some embodiments, several modular build platform units 210 may e.g. be locked together and comprise only one (or at least less than the number of units 210) first securing element 250.

In some embodiments, and as shown, the one or more second securing elements 230 comprises one or more standardised industrial chucks 235 or the like wherein the one or more first securing elements 250 of the build platform 200/the modular build platform units 210 is/are adapted to be secured, during use, by such a standardised industrial chuck 235. The one or more first securing elements 250 of the build platform 200/the modular build platform units 210 may e.g. comprise one or more shanks, tools, work-pieces, or any other suitable elements capable of being securely held, even during use, by a chuck 235 and/or the like. The chuck 235 may e.g. be of the ‘jaw’ type, the ‘collet’ type, etc. Alternatively, other releasably securing elements may be used e.g. like bayonet clamp, magnet, vacuum, etc. elements.

In some particular embodiments, the first securing elements 250 are each particularly an Erowa spigot or similar, mating (in addition to other tools or equipment) with a second securing element (230) in the form of a standardised industrial chuck, like an Erowa chuck (235). Alternatively, other releasably securing elements may be used e.g. like bayonet clamp, magnet, vacuum, etc. elements.

Shown in FIG. 2 the carrier platform 220 comprises, purely as an example, six second securing elements 230/chucks 235. The number may vary according to setup, size of the product(s) to be manufactured, overall size of the build platform 200, etc.

In the particular embodiment of FIG. 2, and corresponding ones, the carrier platform 220 comprises one second securing element 230 adapted to engage, during use, with one first securing element 250 of a given modular build platform unit 210.

As shown, the one or more modular build platform units, each comprising one or more first securing elements, is or are adapted to be releasably secured (and e.g. locked) to a respective carrier platform along a general direction being substantially perpendicular to a build surface of the respective build platform comprising the one or more modular build platform units, and/or a general direction being substantially perpendicular to a side of the carrier platform to which the one or more modular build platform units is to be releasably secured.

Since the modular build platform units 210 are separable or separate they may be handled individually and e.g. also automatically or semi-automatically, which enables very versatile handling possibilities, e.g. for use in a system such as shown in FIG. 9 or other systems.

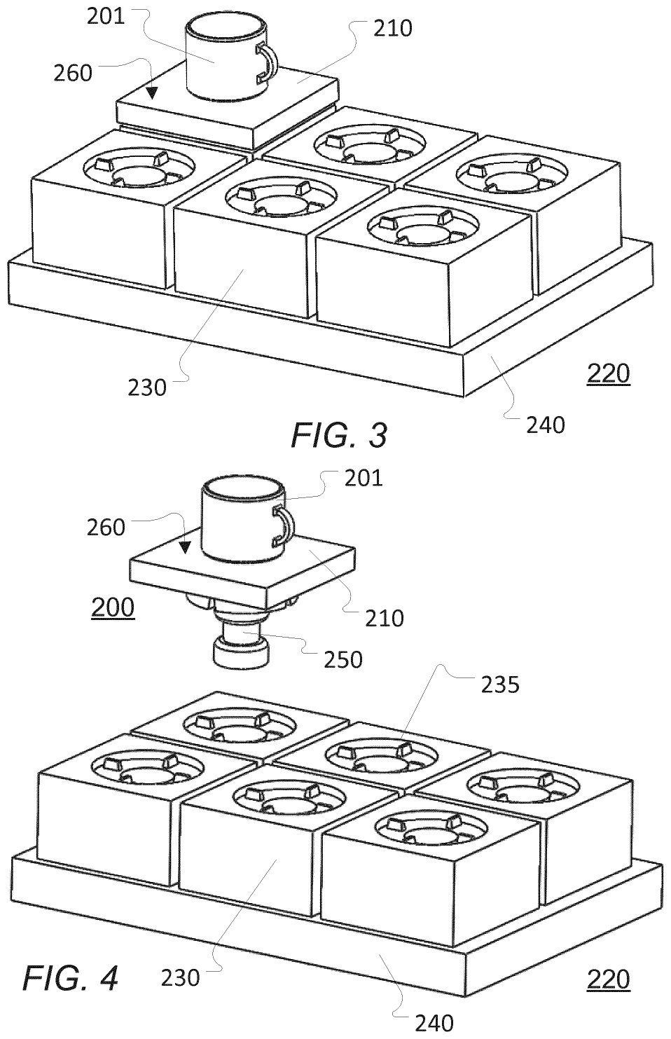

FIG. 3 schematically illustrates a perspective of the carrier platform of FIG. 1 supporting a single modular build platform unit as also shown in FIG. 1.

Shown is a carrier platform 220 supporting—presently—only a single modular build platform unit 210.

This Figure corresponds to FIG. 1 except that only a single modular build platform unit 210 is shown.

FIG. 4 schematically illustrates a perspective view of the carrier platform and the modular build platform unit of FIG. 3 where the modular build platform unit is shown as being separated from the carrier platform.

This Figure corresponds to FIG. 2 except that only a single modular build platform unit 210 is shown.

FIG. 5 schematically illustrates a perspective view of the carrier platform and the modular build platform unit of FIG. 3 shown from another view.

The shown carrier platform 220 and modular build platform unit 210 corresponds to the ones shown and explained in connection with FIGS. 1-4 with the following additions.

In this and other corresponding embodiments, the carrier platform 220 comprises one or more handling or securing elements 250′ enabling the carrier platform 220 to be handled by or secured to at least one handling and/or processing equipment (see e.g. FIG. 9), preferably standardised handling and/or processing equipment such as a robotic arm, conveyer, or other equipment that can move the carrier platform to another part in a manufacturing and/or processing process.

In this particular and corresponding embodiments, the handling or securing elements 250′ are the same as the first securing elements 250, e.g. an element adapted to be secured, during use, by a standardised industrial chuck (see e.g. 235 in FIGS. 2-4).

The carrier platform 220 optionally comprises a number of aligning elements 255 for aligning the carrier platform 220 in or at any suitable equipment.

FIG. 6 schematically illustrates a side view of a carrier platform supporting a build platform with a control circuit indicated.

Shown is a carrier platform 220 and a build platform corresponding to the ones shown and explained in connection with FIGS. 1-5 where a control circuit 500 is further indicated. The control circuit 500 is for receiving a release and lock control signal controlling—preferably on an individual basis for maximum flexibility although it may be different—the one or more second securing elements 230, or more specifically for certain embodiments the chucks (see e.g. 235 in FIGS. 2-4) or similar. The release and lock control signal will control whether a given modular build platform unit 210 can be removed or not from the associated securing element 230.

The control circuit 500 may e.g. be an electrical circuit, a pneumatic circuit, a hydraulic system, a lever system, etc. In the case of a pneumatic circuit it may be beneficial if its open state governs release. In the case of a hydraulic system it may be beneficial if its closed state governs release.

In this way, simple lock and release control, as well as automated mounting and removal of the one or more build platforms, is/are enabled.

In embodiments comprising one or more cleaning or flushing channels (see e.g. FIG. 10 and related description), the control circuit 500 when being a pneumatic or hydraulic system may double in function also as these cleaning or flushing channels or parts thereof.

FIG. 7 schematically illustrates one embodiment of an additive manufacturing device that the various embodiments of a carrier platform and of a build platform e.g. as shown in FIGS. 1-6 and 10 may be used in connection with.

Illustrated is an additive manufacturing device 100 in the form of a top-projection based 3D printer configured to manufacture a given product 201. The device 100 may e.g. comprise a vat 101 or similar with a radiation-curable liquid 103, a radiation source 102 for selectively solidifying radiation-curable liquid in the vat, and a movable carrier platform 220 supporting or comprising a build platform 200 comprising at least one of a plurality of separable or separate modular build platform units (not shown; see e.g. 210 in FIGS. 1-6 and 10) as explained elsewhere.

The device may furthermore comprise an electronic controller 106. The electronic controller 106 may control the relative position of the modular build platform units relative to the liquid, by moving the platform 220/200, and it may control the radiation source to produce the radiation pattern 131 dictated by a product definition file 111, a template or mask, etc. A lens system 104 may e.g. focus the radiation onto the liquid surface.

The controller may be connected to the additive manufacturing device via a suitable data interface or it may alternatively be built into the additive manufacturing device.

During additive manufacture, a layer of the product is formed by selective exposing the radiation-curable liquid at the surface according to a desired pattern. To form a new layer, the movable carrier platform 220 and the build platform 200 will be lowered some distance into the liquid thereby by being ready for exposure of the new layer. This is repeated until the product(s) 201 have been manufactured completely.

FIG. 8 schematically illustrates another embodiment of an additive manufacturing device that the various embodiments of a carrier platform and of a build platform e.g. as shown in FIGS. 1-6 and 10 may be used in connection with.

Illustrated is an additive manufacturing device 100 in the form of a bottom-projection based 3D printer. It comprises a container 101 with radiation-curable liquid 103, a movable carrier platform 220 supporting or comprising a build platform 200 comprising at least one of a plurality of separable or separate modular build platform units (not shown; see e.g. 210 in FIGS. 1-6 and 10) as explained elsewhere, where one or more products may be formed by an additive manufacturing process.

An already manufactured product 201 is shown attached to one of the modular build platform units. Layers are formed by exposing radiation-curable liquid immediately adjacent to the already manufactured part to hardening radiation from a radiation source 102, for instance a Digital Light Processing (DLP) projector. A lens system 104 may e.g. be involved to focus the light from the radiation source onto the radiation-curable liquid. A new layer 412 is formed when radiation-curable liquid on the floor of the container is exposed to the hardening radiation. The pattern of the new layer may e.g. be defined by a product definition file, a template or mask, etc.

In some embodiments, a controller controls the motion of the build platform, the intensity of the hardening radiation, and the image provided by the projector.

When the new layer 412 is formed, it is essentially glued to the floor of the vat. To form a new layer, the newly formed layer must be released from the floor, and the movable carrier platform 220 and the build platform 200 will be raised some distance. This is repeated until the product(s) 201 have been manufactured completely.

FIG. 9 schematically illustrates an additive manufacturing system that may employ the various embodiments of one or more carrier platforms and of one or more build platforms e.g. as shown in FIGS. 1-6 and 10.

Shown is an exemplary system 900 comprising one or more additive manufacturing devices 100 with one, some, or all comprising at least one a movable carrier platform 220 supporting or comprising a build platform comprising at least one of a plurality of separable or separate modular build platform units (not shown; see e.g. 200, 210, and 220 in FIGS. 1-6 and 10) as explained elsewhere.

After one or more products have been manufactured, e.g. as explained previously, the products are moved (manually, semi-automatically, and/or automatically) on the carrier platform or on their individual modular build platform unit(s) to a next post-manufacturing equipment, here 901 being an automatic ultrasonic jet-cleaner or the like.

Next equipment is an automatic UV/IR hardening unit or similar 902 while the next equipment is a quality check unit 903, e.g. utilising a measurement and/or calibration unit. From here, feedback—e.g. adjusting parameters of manufacturing for later batches of product manufacturing—may be provided to the additive manufacturing device(s) 100.

The next equipment(s) is/are various post-processing equipment 904, e.g. like cnc or other milling/lathing, laser coding, tampon printing, PCB circuit sintering, part insertion, multi-material building, gluing, assembly, packaging, sterilisation, etc.

The next equipment is a coating unit or the like 905. If preferred, the one or more products are transferred back to the quality check unit 903—as indicated by the straight arrow to 903—where the quality may be (re-)checked. If additional processing still is needed, the one or more applicable products may be sent (back) to the one or more additive manufacturing devices 100 for additional material deposition (as indicated by the straight arrow from 903 to 100) or to another appropriate equipment, e.g. the one or more various post-processing equipment(s) 904. The one or more applicable products could also be transferred to other equipment, e.g. to repeat an earlier process again.

The next equipment again is a part release unit 906 separating various parts manufactured in one piece if necessary. The release may be done according to any suitable process, e.g. according to co-pending patent application DK PA201570294 by the same applicant.

Next equipment is packaging and shipping 907 and finally delivery 908.

As mentioned earlier, in some embodiments, one or more—preferably all—of the separable or separate modular build platform units may comprise a unique identifier uniquely identifying a given modular build platform unit (and thereby the product manufactured specifically on a particular modular build platform unit). This enables precise information and/or control of what product is manufactured precisely at which modular build platform unit allowing individual and e.g. automated or semi-automated handling and/or (post-manufacture) processing.

This whole process may be automated fully or partly. The whole process or parts thereof may also be carried out manually or semi-manually.

It should be noted, that the products do not need to move as indicated by the arrows and different products may be moved differently as the individual products may not necessarily need to be handled and/or (post)processed by the same equipment.

It should be noted, that further equipment may be used than the ones shown and one or more of the shown pieces of equipment may be omitted based on a given use. The ordering of the pieces of equipment may also be changed.

It should be further noted that modular build platform units of a build platform may be (post)processed and/or used by suitable pieces of equipment as a batch (altogether) and/or be split up and be (post)processed and/or used by different pieces of equipment and/or a different ordering of equipment(s) depending on an actual use or need.

It is also noted, that modular build platform units of a build platform may be split up into two or more groups, followed by processing the groups differently and subsequently joining the modular build platform units together again for being processed together (one at a time or in parallel).

As mentioned, the build platform (and thereby the modular build platform units) may in some embodiments e.g. be for one-time use only while they in other embodiments may e.g. be for repeated use.

FIG. 10 schematically illustrates a further aspect where a build platform comprises one or more cleaning or flushing channels or the like.

Shown is a build platform 200 comprising—in this particular example—one of a plurality of separable or separate modular build platform units 210. Each of the build platform units 210 (or at least one or more of them) of a build platform 200 comprises one or more cleaning or flushing channels or the like 600 comprising a plurality of cavities, openings, and/or the like 610. One cavity or opening (the lowest one, here running internally in the securing element 250) may function as an inlet while the uppermost cavity or opening (in this particular example—extending above the build platform 200/the build platform unit 210; alternatively the upper most cavity or opening may end at the build surface 260) is an outlet to a product (not shown; see e.g. 201 in FIGS. 1-8) while the middle cavity or opening is an outlet to a neighbouring modular build platform unit (not shown). In some embodiments, the middle cavity or opening is not present.

This may be used in a cleaning post-manufacture process (e.g. like 901 in FIG. 9) to spray one or more cleaning agents and pressurised air or similar in hollow manufactured product(s) or manufactured product(s) with hollow connection elements in order to efficiently clean the product(s).

As mentioned in connection with FIG. 6, the one or more cleaning or flushing channels may double in function as a pneumatic or hydraulic control circuit for release and lock of a product (see e.g. 500 in FIG. 6).

It should be noted, that the aspect of one or more cleaning or flushing channel in principle is independent of whether the build platform 200 comprises modular build platform units or not (although they also work particular well with these).

Some preferred embodiments have been shown in the foregoing, but it should be stressed that the invention is not limited to these, but may be embodied in other ways within the subject matter defined in the following claims.

In the claims enumerating several features, some or all of these features may be embodied by one and the same element, component or item. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components or groups thereof.

1. An additive manufacturing device for manufacturing a product, wherein the additive manufacturing device comprises
a build platform comprising a build surface configured to hold or support, during use, at least one product being manufactured by an additive manufacturing process,
wherein
the build platform is a modular building platform comprising at least one of a plurality of separable or separate modular build platform units each separable or separate modular build platform unit
comprising at least one build surface configured to hold or support, during use, at least one product being manufactured during the additive manufacturing process.

2. The additive manufacturing device according to claim 1, wherein the build platform comprises at least two of the separable or separate modular build platform units.

3. The additive manufacturing device according to claim 1, wherein the plurality of separable or separate modular build platform units is adapted to form the build platform as a single coherent build platform.

4. The additive manufacturing device according to claim 1, wherein the additive manufacturing device further comprises at least one carrier platform, each carrier platform being adapted to connect releasably to or attach releasably with, during use, at least one of the separable or separate modular build platform units.

5. The additive manufacturing device according to claim 4, wherein
at least one or some of the separable or separate modular build platform units each comprises one or more first securing elements.

6. The additive manufacturing device according to claim 5, wherein
at least one or some of the carrier platforms each comprises one or more second securing elements,
wherein the first securing elements and the second securing elements are adapted to releasably secure, during use, one or more given modular build platform units to a given carrier platform.

7. The additive manufacturing device according to claim 6, wherein the one or more modular build platform units each comprising one or more first securing elements is or are adapted to be releasably secured to a respective carrier platform along
a general direction being substantially perpendicular to a build surface of the respective build platform comprising the one or more modular build platform units, and/or
a general direction being substantially perpendicular to a side of the carrier platform to which the one or more modular build platform units is to be releasably secured.

8. The additive manufacturing device according to claim 5, wherein the one or more first securing elements for a separable or separate modular build platform unit is located on a side that is opposite a side with the build surface of the separable or separate modular build platform unit.

9. The additive manufacturing device according to claim 5, wherein the one or more first securing elements of a separable or separate modular build platform unit is or are protruding from the separable or separate modular build platform unit.

10. The additive manufacturing device according to claim 5, wherein each respective separable or separate modular build platform unit comprises one first securing element that is located centrally on a side of the respective separable or separate modular build platform unit.

11. The additive manufacturing device according to claim 6, wherein the one or more second securing elements comprises one or more standardised industrial chucks, and the one or more first securing elements are adapted to be secured, during use, by a standardised industrial chuck.

12. The additive manufacturing device according to claim 1, wherein the build platform comprises at least two of the plurality of separable or separate modular build platform units and wherein at least one of the at least two separable or separate modular build platform units are located adjacent or next to at least one other separable or separate modular build platform unit of the at least two separable or separate modular build platform units.

13. The additive manufacturing device according to claim 1, wherein the build platform comprises at least two of the plurality of separable or separate modular build platform units and wherein at least one of the at least two separable or separate modular build platform units are located directly adjacent to at least one other separable or separate modular build platform unit of the at least two separable or separate modular build platform units.

14. The additive manufacturing device according to claim 2, wherein each of the plurality of separable or separate modular build platform units are adjacent or directly adjacent to at least one other separable or separate modular build platform unit.

15. The additive manufacturing device according to claim 5, wherein the one or more first securing elements is further adapted to enable, during use, a given modular build platform unit to be handled by or secured to at least one handling and/or processing equipment.

16. The additive manufacturing device according to claim 5, wherein the carrier platform comprises one or more handling or securing elements enabling the given carrier platform to be handled by or secured to at least one handling and/or processing equipment.

17. The additive manufacturing device according to claim 2, wherein one or more of the at least one carrier platform, each comprises a lock-and-release system adapted to lock or unlock one or more second securing elements of a given carrier platform, preferably on an individual basis, in dependence on a received control signal.

18. The additive manufacturing device according to claim 2, wherein one or more of the at least one carrier platform, each comprises a lock-and-release system adapted to lock or unlock one or more second securing elements of a given carrier platform along
a general direction being substantially perpendicular to a build surface of the respective build platform comprising the one or more modular build platform units, and/or
a general direction being substantially perpendicular to a side of the carrier platform to which the one or more modular build platform units is to be releasably secured.

19. The additive manufacturing device according to claim 1, wherein at least some, preferably all, of the separable or separate modular build platform units, each comprises a unique identifier uniquely identifying the given modular build platform unit.

20. The additive manufacturing device according to claim 19, wherein the unique identifier is selected from the group of: a radio frequency identification tag or similar, a fiducial to be used in a vision or an imaging system, a barcode, a dot matrix code, laser engraving(s), colour coding(s) or marking(s).

21. The additive manufacturing device according to claim 1, wherein one or more of the modular build platform units, each comprises a removable sheet located on a top of the given modular build platform unit wherein the build surface configured to hold or support, during use, at least one product being manufactured is the removable sheet.

22. The additive manufacturing device according to claim 1, wherein the build platform and/or the modular build platform units comprises one or more cleaning or flushing channels ending in one or more cavities and/or openings, wherein the cleaning or flushing channels are adapted to receive, during use, one or more cleaning agents or pressurised air thereby cleaning the at least one product being held or supported by the build platform, a vat or container comprising a liquid used for the manufacturing of the product(s), or the modular build platform units.

23. The additive manufacturing device according to claim 1, wherein the build platform and/or the modular build platform units comprises one or more channels ending in one or more cavities or openings, wherein the channels are adapted to receive, during use, one or more fluid heating or cooling agents thereby heating or cooling, respectively, one or more additively manufactured products or products being additively manufactured being supported by the build platform and/or the modular build platform units.

24. The additive manufacturing device according to claim 1, wherein the build platform and/or the modular build platform units comprises one or more channels or inlets configured to receive a thermoplastic material adapted to be injected by an injection moulding device as part of an injection moulding process.

25. The additive manufacturing device according to claim 1, wherein the build surface of the build platform or the build surface of the modular build platform units comprises an absorbing material.

26. The additive manufacturing device according to claim 1, wherein the build surface of the build platform or the build surface of the modular build platform units comprises a removable or non-removable interface element.

27. The additive manufacturing device according to claim 1, wherein a plurality of separable or separate modular build platform units of a build platform is separated into a first and at least a second group wherein the first group is transferred to a first post-processing device for processing and the second group is transferred to a second postprocessing device for other processing.

28. The additive manufacturing device according to claim 1, wherein the build platform, and thereby the least one of a plurality of separable or separate modular build platform units, is for one-time use only.

29. A modular build platform unit for an additive manufacturing device, the modular build platform unit comprising at least one build surface configured to hold or support, during use, at least one product being manufactured by an additive manufacturing process carried out by the additive manufacturing device, wherein the modular build platform unit is adapted to form, during use, a single unitary build platform when joined or used together with at least one other modular build platform unit.

30. A modular build platform for an additive manufacturing device comprising a build surface configured to hold or support, during use, at least one product being manufactured by an additive manufacturing process, wherein the build platform comprises at least one of a plurality of separable or separate modular build platform units each separable or separate modular build platform unit comprising at least one build surface configured to hold or support, during use, at least one product being manufactured during the additive manufacturing process.

31. The modular build platform unit according to claim 29, wherein the build platform or the modular build platform unit is or are for one-time use only.

32. An additive manufacturing device system comprising at least one additive manufacturing device according claim 1.
